(19) United States
(12) Patent Application Publication
(10) Pub. No.: US 2008/0060785 A1
(43) Pub. Date: Mar. 13, 2008

(54) Climate cup

(76) Inventor: Mark D. Friend, Commerce, MI (US)

Correspondence Address: Mark D. FRiend, 4915 Wavewood Drive, Commerce, MI, 48382, US

(21) Appl. No.: 11/602,095

(22) Filed: Nov. 21, 2006

Related U.S. Application Data
(60) Provisional application No. 60/843,826, filed on Sep. 11, 2006.

(51) Int. Cl. B60H 1/00; B60H 1/32

(52) U.S. Cl. 165/41; 62/239

(57) ABSTRACT

A unit comprising of inlet heating hose 1, shutoff valve 2, pressure sensitive switch 3, vessel heating apparatus 4, shutoff valve 5, vacuum switch 6, solenoid 7, outlet heating hose 8, with or without a cigarette adapter 9, on/off heating and cooling converter switch 10, inlet cooling hose 11, E valve 12, outlet cooling hose 13 and a vessel cooling apparatus 14.

### CROSS-REFERENCE TO RELATED APPLICATIONS

This application relates to and claims priority from U.S. Provisional Patent Application Ser. No. 60/843,826 filed on Sep. 11, 2006, specifications which are incorporated herein by reference.

### FEDERALLY SPONSORED RESEARCH

Not Applicable

### SEQUENCE LISTING OR PROGRAM

None Applicable

### BACKGROUND OF THE INVENTION

1. Field of Invention

This invention relates to a method of cooling or heating a vessel by way of liquids and tubing utilizing the hot liquids from the engine as well as utilizing the air conditioning liquids.

2. Background of Invention

The reason I deduced this product is because when traveling in a vehicle over a long period of time problems arise. For example, beverages have no way of staying hot or cold without the use of a manual cooler which takes up valuable space and is usually powered by a power supply which is mostly a cigarette lighter receiver. For example Slone, Kuel, Fischer and sampson in U.S. Pat. No. 6,918,257 B2 (2005) created a portable cooler which plugs into the cigarette lighter receiver. In the last years technology has been slowly moving towards a vessel holder which has the capabilities to heat or cool liquid by way of a internal power without a cigarette lighter receiver. For example, Klaus, in U.S. pat application Pub No US 2006/0150654 (2006) developed a product which attempts to heat and keep cold liquids by way of air flow from the engine to keep liquids hot and or warm them to desired temp.

In Klaus in U.S. pat application Pub No US 2006/0150654 used the same above said principles and used air flow from the air conditioner to help keep liquids cold and or cool them to desired temp. The Issues with Klaus in U.S. pat application Pub No US 2006/0150654 product stems from the issue of controlling the distribution of the air flow in both cases. Furthermore, Klaus in U.S. pat application Pub No US 2006/0150654 also faces another issue with penetration of the outer drinking vessel shell. To Add, Klaus in U.S. pat application Pub No US 2006/0150654 faces the issue of controlling loss of hot or cold air which Slone, Kuel, Fischer and sampson in U.S. Pat. No. 6,918,257 B2 (2005) address by making their product have an enclosed system. Furthermore, Slone, Kuel, Fischer and sampson in U.S. Pat. No. 6,918,257 B2 (2005) also have the same challenge with controlling loss air when unit is opened. To add, Slone, Kuel, Fischer and sampson in U.S. Pat. No. 6,918,257 B2 (2005) the design uses valuable space.

(a) The manual cooler takes up valuable space in the vehicle.

(b) The manual cooler creates time restraints by way of locating and relocating.

(c) The manual cooler which will lose coldness when unit is opened and exposed to the outside environment.

(d) The manual cooler does not penetrate the outer shell of the vessel through tactile stimulation or element to element process.

(e) The manual cooler has to be powered by an outside source which decreases the ease use factor.

(f) The manual cooler does not have the capabilities of heating a vessel.

(g) The manual cooler uses up valuable resources from the vehicle.

(h) The hardwired cooler loses coldness when unit is opened and exposed to the outside environment.

(i) The hardwired cooler does not penetrate the outer shell of the vessel through tactile stimulation or element to element process.

(j) The hardwired cooler decreases performance of the vehicle by way of utilizing components in the vehicle.

3. Objects and Advantages

Accordingly, besides the objects and advantages of the manual cooler and hardwired cooler described in my above patent, several objects and advantages of the present are:

(a) Climate Cup is built into the vehicle and takes up no extra space.

(b) Climate Cup reduces time restraints because of no locating and relocating.

(c) Climate Cup will have no loss of temperature because of the containment unit being opened to the outside environment of the vehicle.

(d) Climate cup does penetrate the outer shell of the vessel by way of the coiling element to element process.

(e) Climate cup does not require an outside power source, it is hardwired into the vehicle.

(f) Climate cup does not reduce the performance of the vehicle because of the design of the product.

(g) Climate cup has the capabilities of cooling as well as heating by the manipulation of a switch controlling unit.

(h) Climate cup does not decrease the performance of the vehicle by using air to heat or air to cool the vessel.

(i) Climate Cup does not have a closed unit because of design and element to element process, therefore temperature control is manipulated w/ease.

(j) Climate Cup does not decrease performance by utilizing components from the vehicles engine by way of design.

Further objects and advantages are to provide a safe, space saving, easy and economical way to heat a vessel in a vehicle with out giving up performance from the vehicle. The above said will be manufactured into any vehicle. Furthermore, objects and advantages are to provide a safe, space saving, easy and economical way to cool a vessel in a vehicle with out giving up performance from the vehicle. The above said will be manufactured into any vehicle w/air conditioning option. To add, the Climate Cup will allow for the end user not only to regulate a continue temperature on the vessel but also to drastically increase or decrease the temperature of a vessel. Still further objects and advantages will become evident and apparent from a consideration of the ensuing description and drawings.

### SUMMARY

In accordance with the present invention a climate cup is comprised of inlet heating and cooling hoses, shutoff valves, pressure sensitive switch, vessel heating and cooling apparatus, solenoid switch, outlet heating and cooling hoses and heating and cooling switches.

In the drawings, closely related figures have the same number but different numerical suffixes.

### DRAWINGS—FIGURES

FIGS. 1,1 to 1,14 illustrate various aspects the comprising unit, heating inlet hose, cooling inlet hose, heating outlet hose, cooling outlet hose, vessel heating apparatus, cooling heating apparatus, shutoff valves, pressure sensitive switch, solenoid switch and on/off heating and cooling converter and a cigarette lighter adapter.

FIGS. 2,1 to 2,14 illustrate various aspects the comprising unit, heating inlet hose, cooling inlet hose, heating outlet hose, cooling outlet hose, vessel heating apparatus, cooling heating apparatus, shutoff valves, pressure sensitive switch, solenoid switch and on/off heating and cooling converter switch.

DRAWINGS - Reference numerals

| | | | |
|---|---|---|---|
| 1 | Inlet Heating hose | 5. | shutoff valve 2 |
| 2 | Shutoff valve 1 | 6. | Vacuum switch |
| 3 | Pressure sensitive switch | 7. | Solenoid |
| 4 | Vessel heating apparatus | 8. | Outlet heating hose |
| 9 | Cigarette lighter adapter | | |
| 10 | On/off heating and cooling | | |
| | converter switch | | |
| 11 | Inlet cooling hose | | |
| 12 | E valve | | |
| 13 | Outlet cooling hose | | |
| 14 | Vessel cooling apparatus | | |

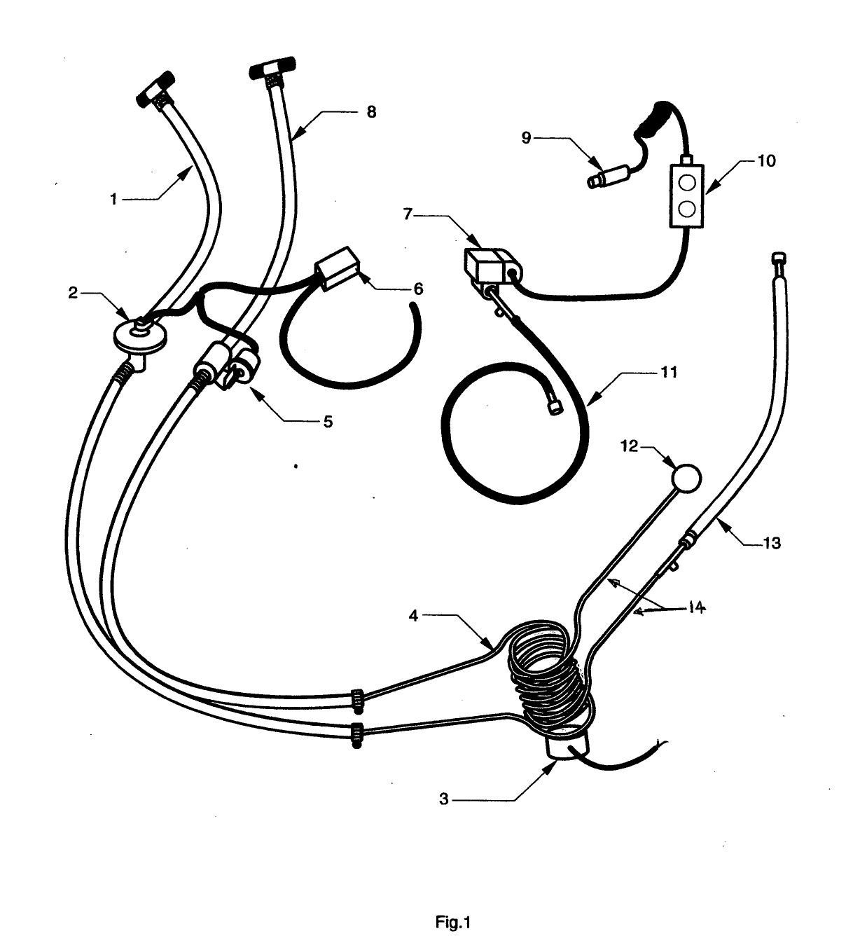

### DETAILED DESCRIPTION—FIGS. 1,1 to 1,14—PREFERED COMPRISING UNIT

Preferred comprising unit of the present invention is illustrated in FIGS. 1 to 1, 14 (top view) the inlet heating hose 1. The (top view) of vacuum shutoff valve 12 is connected to inlet heating hose 1. The (top View) of the pressure sensitive switch 3 is located at the bottom of vessel heating apparatus 4 and vessel cooling apparatus. The (top view) shut off valve 2, 5 is positioned on the outlet heating hose 8. The (top view) of the solenoid is adhered to the E valve 12. The (top view) of the vacuum switch is connected to shut off valve 25 and shutoff valve 12. The (top view) of the cigarette adapter 9 is attached to the on/off cooling converter switch 10. The (top view) inlet cooling hose 11 is attached to the solenoid 7. The (top view) of the E valve 12 is attached to the vessel cooling apparatus 14 which is attached to outlet cooling hose 13 which is attached to solenoid 7.

Preferred comprising unit of the present invention is illustrated in FIGS. 2, 1 to 2, 14 (top view) the inlet heating hose 1. The (top view) of vacuum shutoff valve 12 is connected to inlet heating hose 1. The (top View) of the pressure sensitive switch 3 is located at the bottom of vessel heating apparatus 4 and vessel cooling apparatus. The (top view) shut off valve 2, 5 is positioned on the outlet heating hose 8. The (top view) of the solenoid is adhered to the E valve 12. The (top view) of the vacuum switch is connected to shut off valve 25 and shutoff valve 12. The (top view) of on/off heating and cooling converter switch 10 is connected to solenoid 7. The (top view) inlet cooling hose 11 is attached to the solenoid 7. The (top view) of the E valve 12 is attached to the vessel cooling apparatus 14 which is attached to outlet cooling hose 13 which is attached to solenoid 7.

### Operations—FIGS. 1, 1 to 1, 14

The approach of using the climate cup to heat and cool vessels is a new method by which an inlet heating hose 1 in FIG. 1 will transport heated liquid from the engine of the vehicle passing or being stopped by shutoff valve 12 in FIG. 1 which is connected to vacuum switch 6 in FIG. 1. The heated liquid will then be transported to the vessel heating apparatus 4 in FIG. 1 which will be controlled by the pressure sensitive switch 3 in FIG. 1. The heated liquid will then enter the outlet heating hose 8 in FIG. 1 traveling in the direction of the shutoff valve 25 in FIG. 1 which is connected to the vacuum switch 6 in FIG. 1 which will control flow or stop flow of the heated liquid. The above flow of heated liquid will be controlled by the on/off heating and cooling converter switch 10 in FIG. 1. The inlet cooling hose 11 FIG. 1 will transport cooled liquid from the Air conditioning unit in the vehicles cooled flow of liquid will be controlled by solenoid 7 in FIG. 1 and on/off heating and cooling converter switch 10 in FIG. 1 the cooled liquid will then travel to the vessel cooling apparatus 14 which will be controlled by the pressure sensitive switch 3 in FIG. 1. The cooled liquid will then flow through outlet cooling hose 13 in FIG. 1 in the direction of the vehicles air conditioning unit. The power source for the invention in FIG. 1 derives from cigarette lighter adapter.

### Operations—FIGS. 2, 1 to 2, 14

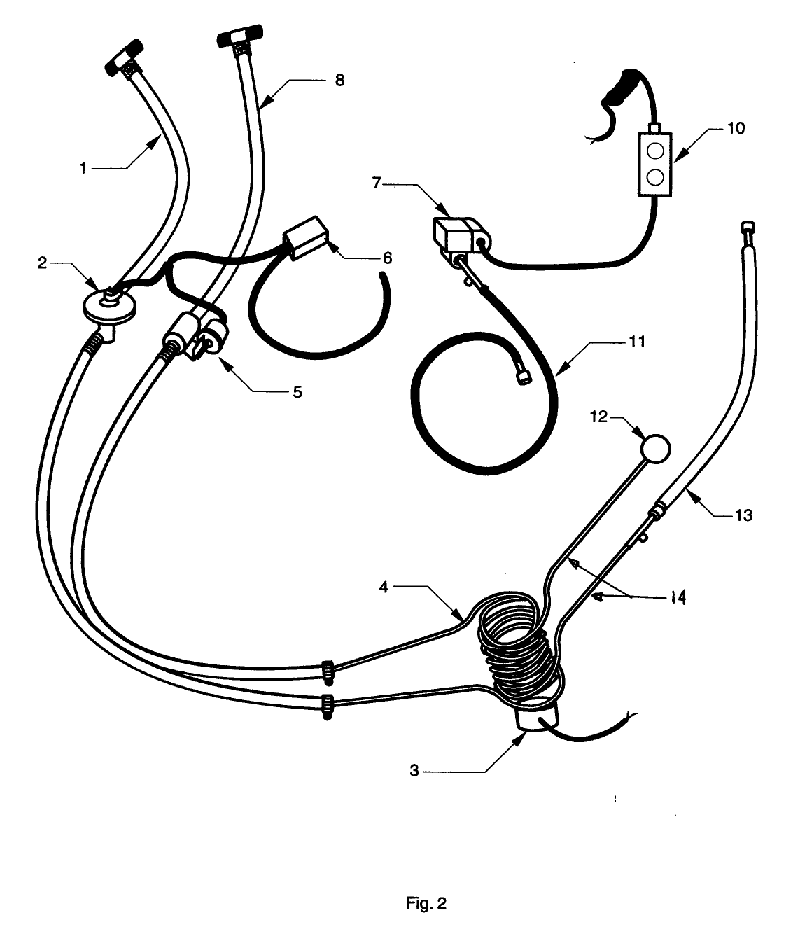

The approach of using the climate cup to heat and cool vessels is a new method by which an inlet heating hose 1 in FIG. 2 will transport heated liquid from the engine of the vehicle passing or being stopped by shutoff valve 12 in FIG. 2 which is connected to vacuum switch 6 in FIG. 2. The heated liquid will then be transported to the vessel heating apparatus 4 in FIG. 2 which will be controlled by the pressure sensitive switch 3 in FIG. 2. The heated liquid will then enter the outlet heating hose 8 in FIG. 2 traveling in the direction of the shutoff valve 25 in FIG. 2 which is connected to the vacuum switch 6 in FIG. 2 which will control flow or stop flow of the heated liquid. The above flow of heated liquid will be controlled by the on/off heating and cooling converter switch 10 in FIG. 2. The inlet cooling hose 11 FIG. 2 will transport cooled liquid from the Air conditioning unit in the vehicles cooled flow of liquid will be controlled by solenoid 7 in FIG. 2 and on/off heating and cooling converter switch 10 in FIG. 2 the cooled liquid will then travel to the vessel cooling apparatus 14 in FIG. 2 which will be controlled by the pressure sensitive switch 3 in FIG. 2. The cooled liquid will then flow through outlet cooling hose 13 in FIG. 2 in the direction of the vehicles air conditioning unit.

### Advantages

From the description above the evaluator will see the numerous advantages of my climate cup become evident.
(a) Climate Cup is built into the vehicle and takes up no extra space.
(b) Climate Cup reduces time restraints because of no locating and relocating.
(c) Climate Cup will have no loss of temperature because of the containment unit being opened to the outside environment of the vehicle.
(d) Climate cup does penetrate the outer shell of the vessel by way of the coiling element to element process.
(e) Climate cup does not require an outside power source, it is hardwired into the vehicle.
(f) Climate cup does not reduce the performance of the vehicle because of the design of the product.
(g) Climate cup has the capabilities of cooling as well as heating by the manipulation of a switch controlling unit.
(h) Climate cup does not decrease the performance of the vehicle by using air to heat or air to cool the vessel.
(i) Climate Cup does not have a closed unit because of design and element to element process, therefore temperature control is manipulated w/ease.
(j) Climate Cup does not decrease performance by utilizing components from the vehicles engine by way of design.

### Conclusions, Ramifications and Scope

Accordingly the examiner will see that the climate cup with its encompassed components will heat and cool liquids safely and easily without losing valuable resources along the way from the vehicle. This will be done by way of a heating liquid or a cooling liquid traveling through various hoses, switches and pumps. Furthermore, the climate cup has additional advantages in that
It allows the vehicle to have full performance;
It allows the vehicle to utilize all of its potential valuable space;
It permits the end user to have more control over the regulation of the temperature;
It allows for the end user not only to heat but also cool using element to element process which in turn creates a more temperature regulated environment;
It allows the end user to heat or cool vessels rapidly by way of element to element process;
It allows the end user by way of switch to heat or cool with out losing the regulated temperature environment;
It permits the end user to control on/off switch by way of pressure sensitive switch;

We claim:

1. A method of heating and cooling vessels through liquids, hoses, pumps, solenoids switches and hardwired components located in a vehicle.

2. A method of heating and cooling vessels through liquids, hoses, pumps, solenoids switches, cigarette adapter and hardwired components located in a vehicle.
